(19) United States
(12) Patent Application Publication
(10) Pub. No.: US 2009/0145335 A1
(43) Pub. Date: Jun. 11, 2009

(54) Portable work station

(76) Inventors: Michael Harmik Panosian, Glendale, CA (US); Joshua Keeler, Glendale, CA (US); James Stobar, Glendale, CA (US)

Correspondence Address: Michael H. Panosian, 2425 Canada Blvd. (#102), Glendale, CA, 91208, US

(21) Appl. No.: 12/001,417

(22) Filed: Dec. 10, 2007

(51) Int. Cl. B25H 1/04

(52) U.S. Cl. 108/28

(57) ABSTRACT

A portable work station includes a collapsible and expandable work bench including a plurality of panels or leafs pivotably connected to each other to form a central panel that forms an upper surface of the collapsed work station and a pair of side or lateral panels that can be moved to a horizontal plane co-extensive with the central panel. Legs are mounted for movement between retracted positions within the work bench when the work bench is collapsed and extended positions below the plane for supporting the work bench in its expanded condition for use as a workbench. Adjustable securing member(s) are provided for securing variably sized works on an upper work surface parallel to said horizontal plane when the work station is expanded and supported on the legs.

### BACKGROUND OF THE INVENTION

1. Field of the Invention

The present invention generally relates to work stations and, more specifically, to a portable workstation.

2. Description of the Prior Art

Portable workstations have been known. However, known workstations have generally been limited as to the functions that they can provide. Most known workstations are generally bulky and inconvenient to transport and set up. Once set up, they generally provide a simple surface on which work can be done. Functions such as securing a work-piece to the work surface and alignment of work-pieces on the work surface have typically required additional tools such as vices, clamps, etc.

### SUMMARY OF THE INVENTION

Accordingly, it is an object of the invention to provide a workstation that does not possess the disadvantages inherent in such known prior workstations.

It is another object of the invention to provide a workstation that is portable, simple and convenient to use and transport.

It is still another object of the invention to provide a workstation that is both portable and provides a number of different built-in functions that avoid the need to use auxiliary tools or components to use the workstation.

It is yet another object of the invention to provide a portable workstation of the type under discussion that provides a sufficiently large working surface area for use with a majority of projects undertaken by both professionals and “do-it-yourselfers”.

It is a further object of the invention to provide a workstation as in the previous objects that provides a fully integrated and full featured unit that also provides storage areas for storing small tools and general hardware.

It is still a further object of the invention to provide a workstation of the type under discussion that provides adjustable legs for adjusting the height of the work surface to a desired height for any given application.

### BRIEF DESCRIPTION OF THE DRAWINGS

These and other objects of the present invention will become apparent when it is considered in detail in the below specification, taken with the drawings as follows:

FIG. 1 is a perspective view of a portable workstation in accordance with the invention when in a fully collapsed condition; and

FIG. 2 is a perspective view of the portable workstation shown in FIG. 1 but shown in a fully opened condition when ready for use.

### DESCRIPTION OF THE PREFERRED EMBODIMENT

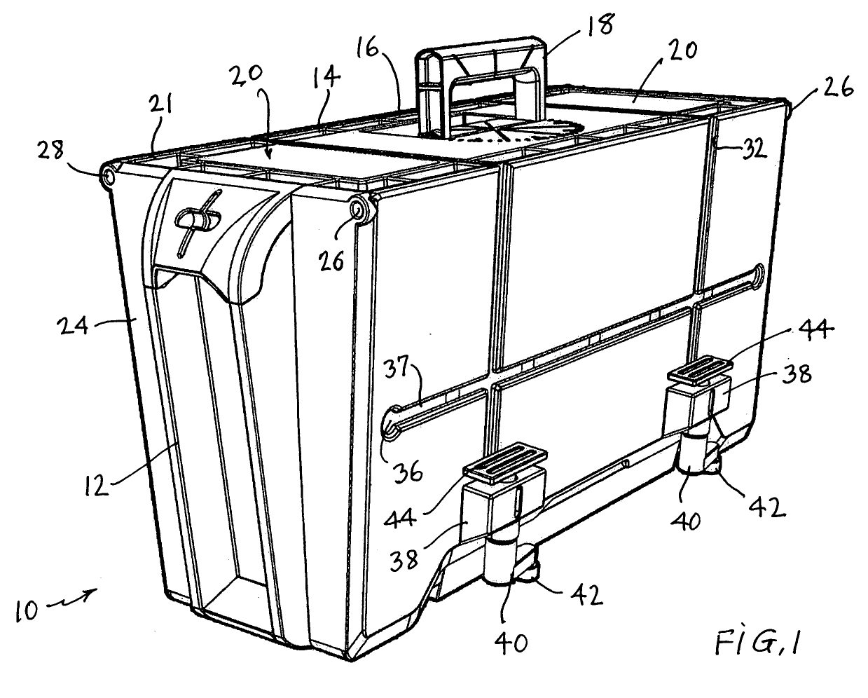

Referring now specifically to the drawings, in which identical or similar parts are designated by the same reference numerals throughout, and first referring to FIG. 1, the portable workstation in accordance with the invention is generally designated by the reference numeral 10.

The workstation 10 includes a central body 12 that is generally rectangular as shown and defines a top surface 14. A recess 16 is provided in the top surface 14 to receive a handle 18, shown in an extended vertical position suitable for being gripped as when carrying the workstation. Once the workstation is not being transported, the handle 18 can be pivoted or rotated downwardly to be fully received within the recess 16 so that the handle does not project above the top surface 14. Additional recesses or cavities 20, 21 may be provided to either side of the handle 18, as shown, that may be used for storage of small tools or items of hardware that may be required during use of the workstation.

To either side of the central body 12 there are provided two leafs or extensions 22, 24 that have heights substantially equal to the height of the central body 12, as viewed in FIG. 1, and are pivotally connected to the central body 12 at the upper ends thereof about pivots 26, 28. When the workstation is not in use or is being transported, the leafs or extensions 22, 24 can be folded downwardly as shown in FIG. 1 to be generally coextensive with the central body 12. Each of the leafs or extensions 22, 24 has an exterior surface 30 provided with at least one but preferably an array of parallel longitudinal slots 32, 34 as shown, and at least one transverse slot 36. The slots are preferably marked with suitable scales 37, for reasons that will become apparent. An adjustable block 38 is provided for each slots 32, 34. Each block 38 includes a crank 40 and a knob 42 that can be manually rotated to adjust the positions of the pads 44 along the direction of the slots 32, 34. Any screw or gear mechanism may be used within the blocks 38 to cause linear movements of the pads 44. Also, the blocks 38 can be moved along the slots 32, 34 and secured at any desired position by any suitable means, such as the use of detents or fasteners.

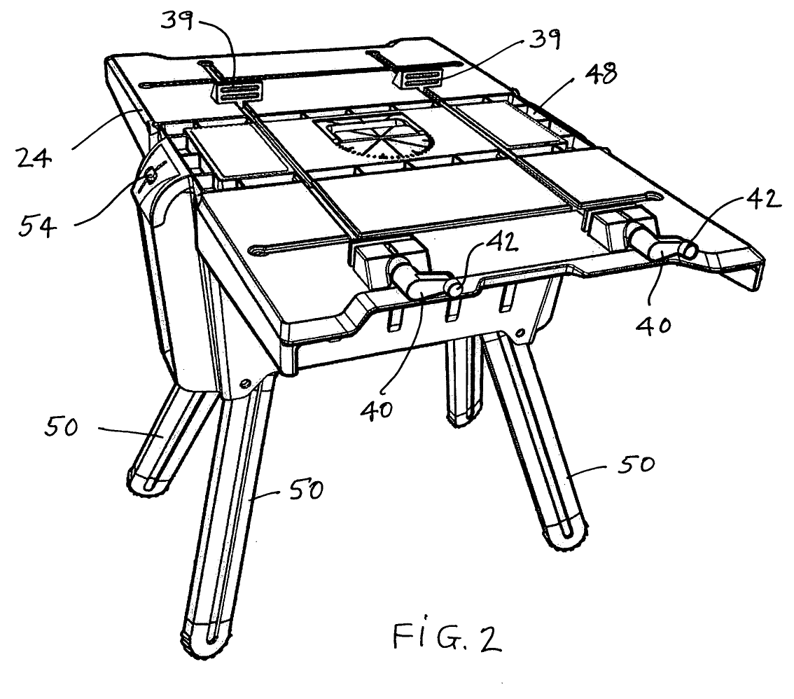

Referring to FIG. 2, the portable workbench 10 is shown in its fully extended or opened condition. In this condition, each of the leafs or extensions 22, 24 has been pivoted upwardly about respective pivots 26, 28 and locked in the extended positions by any suitable means. Each block 38 is preferably also provided with a scale 46 that provides an indication of the positions of the pads 44 relative to the blocks 38, which provides a fine adjustment. Coarse adjustments are provided by moving the blocks 38 along the slots 32, 34. Opposite the adjustable blocks 38 there are provided, along each of the slots 32, 34, fixed blocks 39 that may similarly be secured along the slots in the same or similar ways as the adjustable block 38. It will be appreciated that by initially positioning the adjustable and/or fixed blocks 38, 39 at distances substantially corresponding to the size of the work to be clamped a suitable degree of clamping can be achieved by rotating the cranks 40 to advance the pads 44 in the directions of the fixed blocks 39. Also, while the block 38, 39 are shown positioned for clamping along the guides or slots 32, 34 they or other such blocks can also be mounted along the transverse slots 36 to allow clamping along the directions of those slots. By using such pairs of blocks along both longitudinal and transverse slots a work can be clamped against movements in any direction along the top surface of the work station, which now consists of the top surface 14 of the central body 12 as well as the outer surfaces 30 of each of the leaves or extensions 22, 24.

Suitable trays 48, provided with appropriately sized compartments, can be placed within the recesses 28 to contain or store small items, such as small hand-tools or hardware. Such trays may then be removed from the recesses 28 when work has been completed and the workstation is collapsed for storage or transportation.

Locking lever 54 is provided for releasing legs 50 from the central body 12. The lever 54, which is positionable between releasing and locking positions allow the legs 50 to be moved to either retracted or extended positions, as shown in FIG. 2. Preferably, a suitable means, such as a lock, may be used to secure the lever 54 in a locked position to prevent the legs from inadvertently extending or telescoping outwardly when the workstation is being transported or retracting inwardly when the workstation is in use.

It will be appreciated that the portable workstation in accordance with the invention can be converted from a compact portable unit to a full-functioned workstation that incorporates integrated clamps to secure a work-piece thus avoiding the need to use auxiliary holding devices or clamps. Recesses and trays may be provided below the top surface of the workstation to contain and store small tools and items of hardware that can be quickly and conveniently accessed without compromising any of the work surface. The portable workstation is, thus, ideal for work in the field as well as “do-it-yourselfers” performing smaller projects around the house. When not in use, the portable workstation can be fully collapsed and stored almost anywhere, such as in the closet, basement, garage, trunk of an automobile or the like.

While the preferred embodiments have been shown and described, it will be understood that the there is no intention to limit the invention by such disclosure, but rather, it is the intention to cover all modifications and alternate constructions falling within the spirit and scope of the appended claims.

1. A portable work station comprising a collapsible and expandable work bench including a plurality of panels or leafs pivotably connected to each other to form a central panel that forms an upper surface of the collapsed work station and a pair of side or lateral panels that can be moved to a horizontal plane co-extensive with said central panel; leg means mounted to movement between retracted positions within said work bench when the work bench is collapsed and extended positions below said plane for supporting said work bench in its expanded condition for use as a workbench; and adjustable securing means for securing a variably sized works on an upper work surface parallel to said horizontal plane when said work station is expanded and supported on said leg means.

2. A portable work station as defined in claim 1, further comprising gripping means on said central panel for gripping by the hand of a user for transporting the work bench in its collapsed condition.

3. A portable work station as defined in claim 1, wherein said securing means comprises a plurality of surface grooves or channels and a plurality of blocks mounted for selective movement along said grooves or channels.

4. A portable work station as defined in claim 3, wherein at least one of said blocks includes adjusting means for limited adjustments along an associated groove or channel, to create a vise-like holder of the work.
